(19) United States
(12) Patent Application Publication
(10) Pub. No.: US 2015/0167179 A1
(43) Pub. Date: Jun. 18, 2015

(54) PHOTOELECTROCHEMICAL CELL AND METHOD FOR THE SOLAR-DRIVEN DECOMPOSITION OF A STARTING MATERIAL

(71) Applicant: NOVAPECC GMBH, Wien (AT)

(72) Inventors: Jürgen Fleig, Baden (AT); Martin Ahrens, Wien (AT); Markus Haider, Wien (AT); Karl Ponweiser, Wiener (AT); Georg Brunauer, Stockerau (AT)

(73) Assignee: NOVAPECC GMBH, Wien (AT)

(21) Appl. No.: 13/877,686

(22) PCT Filed: Oct. 3, 2011
(86) PCT No.: PCT/AT11/00408

§ 371 Date: Aug. 6, 2013

(30) Foreign Application Priority Data
Oct. 4, 2010 (AT) A 1655/2010

(51) Int. Cl. C25B 1/00; C25B 9/06

(52) U.S. Cl. CPC C25B 1/003; C25B 9/06

(57) ABSTRACT

The invention relates to a photochemical cell (1) and to a method for the solar-driven decomposition of a starting material, in particular water or carbon dioxide, into a product gas bound therein, in particular hydrogen or carbon monoxide, comprising a supply line (7) for the starting material, a discharge line (9) for the obtained product gas, a first electrode (2) made of a photoelectrically active material and exposed to solar radiation (3′, 3″) during operation, and a second electrode (5), wherein the electrodes (2, 5) are connected to each other in a closed circuit by means of an electron conductor (4) for transporting electrons excited by the solar radiation (3′, 3″) in the first electrode (2) and an ion conductor (6) for transporting ions produced in the decomposition of the starting material, wherein an electrolyte made of a heat-resistant solid material and arranged between the electrodes (2, 5) is provided as the ion conductor (6).

The invention relates to a photoelectrochemical cell for the solar-driven decomposition of the starting material, especially water or carbon dioxide, into a product gas bound therein, especially hydrogen or carbon monoxide, comprising a feed line for the starting material and a discharge line for the obtained product gas, a first electrode made of a photoelectrically active material and exposed to solar radiation during operation, and a second electrode, wherein the electrodes are connected to each other in a closed circuit by means of an electron conductor for transporting electrons excited by the solar radiation in the first electrode and an ion conductor for transporting ions produced in the decomposition of the starting material.

The invention further relates to a method for the solar-driven decomposition of the starting material, especially water or carbon dioxide, into a product gas bound therein, especially hydrogen or carbon monoxide, wherein charge carriers in the form of electron-hole pairs are excited in a photoelectrically active first electrode by means of solar radiation, wherein the excited electrons are conducted to a second electrode and the starting material is applied to one of the electrodes, which starting material will be decomposed by means of the excited charge carriers, with ions being produced which are transported in a closed circuit to the respective other electrode, with the obtained product gas being discharged.

Solar energy represents one of the most important regenerative primary energy sources, which exceeds the world energy demand by several times. The efficient use of solar energy has proven to be difficult because the energy density of solar radiation is low in comparison to fossil fuels. A further problem is posed by the varying availability of solar energy. Consequently, there is a big challenge in converting solar energy in the most efficient manner into a storable and transportable secondary energy carrier. Considerable efforts have already been made to convert solar energy into chemically bound energy. Hydrogen has increasingly gained in importance most recently as a secondary energy carrier. In view of the serious effects of greenhouse gases on the world climate, solutions are sought in order to efficiently convert carbon dioxide into carbon monoxide.

For the decomposition of water into molecular hydrogen (and oxygen that occurs as the by-product) photoelectrochemical cells (PEC—photoelectrochemical cell) were developed in the state of the art. Such a cell has been described for example in US 2008/0131762 A1.

The photoelectrochemical cells usually consist of a photo anode, a semiconducting material which is subjected to solar radiation for generating electron-hole pairs, and at least one counterelectrode forming a cathode. The electrodes are immersed into an electrolytic solution. A current-conducting connection between the electrodes is further provided for closing the circuit. The current generated by solar energy on the photo anode will flow to the opposite cathode in order to react with the H⁺ ions into molecular hydrogen. This technology is based on the internal photo effect, wherein the short-wave radiation components which can excite electron-hole pairs in the semiconductor are converted into molecular hydrogen and therefore into chemical energy.

The conversion of solar energy into chemical energy shows a low level of efficiency in the known photoelectrochemical cells because only the short-wave radiation components whose energy is sufficient for exciting the electron-hole pairs can be utilized. The long-wave radiation components whose photon energy is lower than the band gaps of the semiconducting photoelectrode represent thermal energy that cannot be utilized for the conversion of the starting material. In the known PECs the input of heat by solar radiation is even undesirable because the used liquid electrolytes can be chemically unstable at higher temperatures. A relevant disadvantage of the known photoelectrochemical cells (PEC) is that photocorrosion can occur on the photoelectrode, which means the decomposition of the photoelectrode received in the aqueous electrolyte under the influence of solar radiation. The occurrence of photocorrosion leads to the oxidizing of the photoelectrically active electrode, wherein electrode material will dissolve. Despite intensive research it has not been managed until now to ensure the stability of the photoactive electrode material in the liquid electrolyte under radiation in a satisfactory manner.

High-temperature electrolysis was developed in the state of the art for obtaining hydrogen, in which water vapor with temperatures of approximately 800 to 1000° C. is converted into hydrogen and oxygen. An electrical voltage is applied to electrodes connected in a current-conducting way, between which an ion-conducting solid electrolyte (e.g. calcium yttrium zirconium oxide or perovskite) is arranged. The conversion of the water vapor at increased temperature shows a comparatively high level of efficiency. The electrolysis of water comes with the principal disadvantage that current needs to be supplied from an external power source. Although this current can be produced by a photovoltaic installation which merely uses the short-wave radiation components for generating power in analogy to the photo electrochemical cells, the thermal energy of the long-wave radiation components however will be lost or will not be available for electrolysis. Moreover, transmission losses are unavoidable when the current gained by photovoltaic is conducted to the high-temperature electrolysis apparatus.

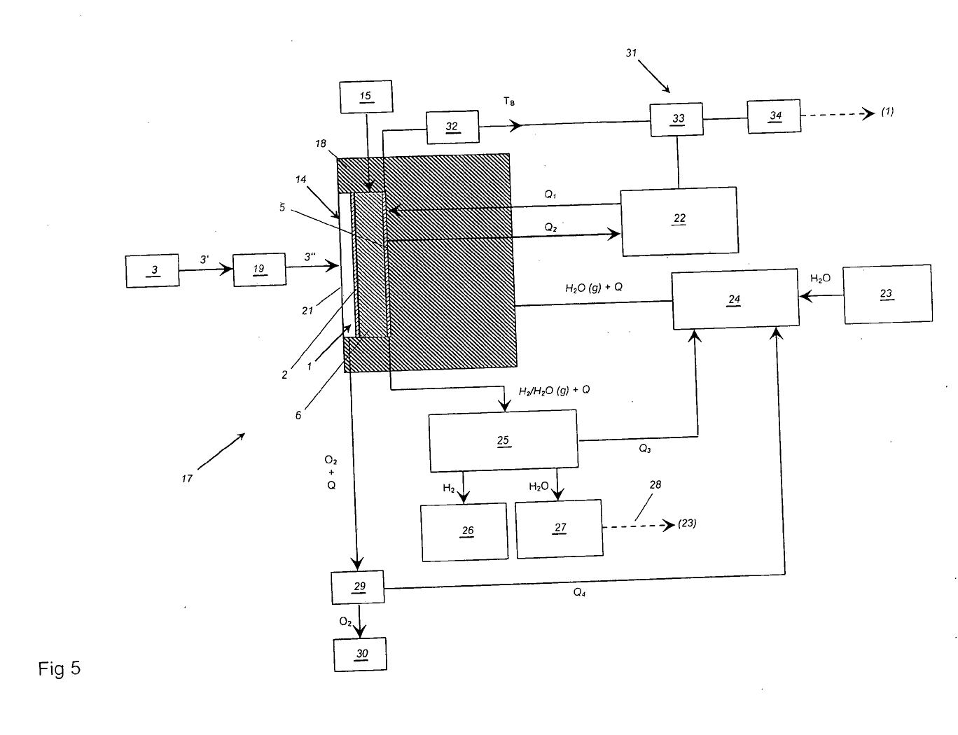

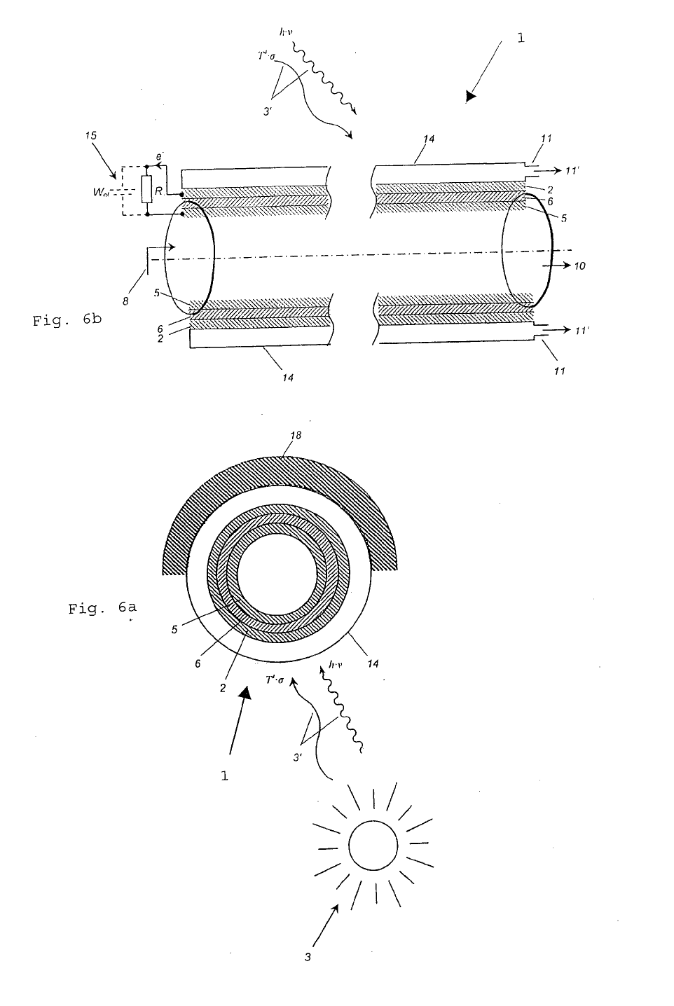

Various embodiments of an apparatus for producing hydrogen by means of electrolysis in an electrolytic cell are known from DE 693 25 817 T2. The apparatus comprises a concentration device in order to focus concentrated solar radiation to an arrangement of solar cells. The electricity produced in the solar cells will be utilized for operating the electrolytic cell. Furthermore, the thermal waste heat can be utilized in that the long-wave solar radiation is supplied to a receiver for generating thermal energy. The receiver in the form of a heat exchanger or the like will be connected to a feed flow of water for the electrolytic cell in order to produce water vapor with a temperature of approximately 1000° C., which enables efficient operation of the electrolytic cell. According to the embodiment of FIGS. 5 and 6, both the electrolytic cell and also the solar cell are arranged in the focal point of a concentration dish. The electrolytic cell is enclosed by a tubular heat shield or distributor. The electrolytic cell comprises a tube made of yttrium-stabilized zirconium, which is covered on the inside and the outside with platinum electrodes. Accordingly, solar radiation is split up into components of long and short wavelength which can be utilized independently of one another and in a spatially separated manner for producing thermal energy for the operation of the electrolytic cell and for generating electricity in the solar cells.

U.S. Pat. No. 4,170,534 discloses a galvanic cell with a solid electrolyte.

U.S. Pat. No. 4,511,450 describes an apparatus for producing hydrogen, in which the long-wave components of solar radiation will heat water in order to maintain the circulation of the water in the apparatus. The short-wave components will be utilized for splitting water by means of photoelectrolysis in a photoactive layer.

In contrast to this, it is the object of the present invention to provide an apparatus and a method of the kind mentioned above which enables efficient utilization of solar energy for producing product gases. Furthermore, the disadvantages occurring in the known photoelectrochemical cells and the associated methods shall be avoided or reduced.

This object is achieved by a photoelectrochemical cell with the features of the characterizing part of claim 1 and a method with the features of the characterizing part of claim 12. Preferred embodiments of the invention are provided in the dependent claims.

Accordingly, a heat-resistant solid material is arranged between the electrodes, which material produces an ion-conducting connection between the electrodes. The use of the heat-resistant solid electrode allows performing the processes running in the photoelectrochemical cell, i.e. at least the excitation of the photoelectrode, the decomposition of the starting material and the ion transport through the electrolyte, at an operating temperature which is substantially increased with respect to room temperature, appropriately more than 300° C. A considerable increase in the efficiency can be achieved in this manner in the production of the product gases, as will be explained below in closer detail. Solar radiation has short-wave radiation components whose photon energy is larger than the band gap between the valence band and the conduction band of the semiconducting material of the first electrode. The short-wave radiation excites electron-hole pairs in the photoactive first electrode by means of the internal photo effect. The electrons excited in the first electrode will be conducted via the current conductor to the opposite second electrode in order to decompose the starting material into the product gas. Solar radiation further comprises long-wave radiation components which do not overcome the band gap in the photoactive first electrode and are therefore unable to excite any electrons. These components therefore act as thermal energy (as also the energy of the short-wave components which exceeds the band gap), which thermal energy remained unused in known photoelectrochemical cells or was avoided as an undesirable side effect to the highest possible extent. In contrast to this, the thermal energy in the technology in accordance with the invention will be converted into internal energy of the photoelectrochemical cell in order to increase the operating temperature. The heat-resistant solid electrolyte withstands the increase operating temperatures by the heat input by the long-wave radiation components. Furthermore, this prevents photocorrosion which frequently occurs in the case of aqueous electrolytes. The increased operating temperature leads to the advantage on the one hand that the band gap of the semiconducting material of the photoactive first electrode will be reduced. This connection between temperature and band gap is known in the state of the art as the model equation of Varshni. The spectrum of solar radiation which can be utilized for exciting electrons in the photoelectrically active first electrode will be expanded towards the long-wave range with increasing operating temperature, so that the charge carrier density generated in the photoactive first electrode will be increased substantially. As a result, the current conducted to the opposite second electrode can be increased in order to improve the turnover of the starting material. An increased operating temperature, which is only enabled by the use of heat-resistant solid materials for the electrolyte, leads to the further advantage that the thermodynamic decomposition voltage (also known as chemical potential or Gibbs energy) of the starting material will be reduced, which means the minimum required difference between the electrode potentials. For the decomposition of water the standard voltage potential at room temperature (298.15 Kelvin) and an ambient pressure of 1 bar is approx. 1.23 V, which in this case corresponds to a chemical potential or Gibbs energy of 1.23 eV. In the case of an increase of the operating temperature to preferably 500° C. to 900° C. (773 to 1175 Kelvin), the voltage potential of water will decrease to 0.9 to 1 V. The photoelectrochemical cell is configured to conserve the operating temperature by the thermal energy of solar radiation at a higher level in order to utilize the advantages of a lower decomposition voltage for the starting material and the increased electron density in the photoactive first electrode. As a result, an especially efficient conversion of solar energy can be achieved in that the radiation components which are not involved in the excitation of the electron-hole pairs are utilized for heating the photoelectrochemical cell. On the other hand, the use of the solid electrolyte reliably prevents photocorrosion of the photoelectrically active first electrode due to solar radiation even in the case of an increased operating temperature. As a result, electrolysis technology is provided which obtains the current required for the decomposition of the starting material from the solar excitation of the photoactive first electrode, wherein a solid electrolyte is provided as an ion conductor with respect to the increased operating temperatures. The efficiency in comparison with known photoelectrochemical cells which can utilize only a narrow bandwidth of the radiation spectrum can be increased considerably. On the other hand, an increase in efficiency is achieved in comparison with electrolytic apparatuses with external power supply for maintaining the potential difference between the electrodes. As a result, a photoelectrical-thermochemical cell and a respective photoelectrical-thermochemical method are created which combine the photoelectric charge carrier generation known from conventional photoelectrochemical cells with a thermally supported chemical decomposition of the starting material, which is enabled by using the heat-resistant solid electrolyte.

In order to ensure the thermal stability of the photoelectrochemical cell in a wide temperature range, especially for operating temperatures of more than 300° C., it is advantageous when the electrolyte consists of a solid oxide material, especially zirconium dioxide (ZrO₂) or a mixed lanthanum oxide, preferably lanthanum zirconate (LaZrO₃) or lanthanum cerate (LaCeO₃). These materials allow operating the photoelectrochemical cells at operating temperatures of at least more than 300° C. in order to utilize a significant reduction in the chemical potential during the decomposition of the starting material and an increased electron yield in the photoactive material of the first electrode. The used solid oxide material for the ion conductor depends on the type of the transported ions. ZrO₂ as the solid electrolyte is appropriately provided for transporting O²⁻ ions, which enables an operation of the photoelectrochemical cell at operating temperatures of preferably 700 to 1,000° C. An electrolyte of a mixed lanthanum oxide, especially lanthanum zirconate or lanthanum cerate, is preferably provided for a transport of H⁺ ions, which allows the use of the cell in a preferred temperature range of 300 to 700° C. When the photoelectrochemical cell is used for the reduction of carbon dioxide, only O²⁻ ion conduction is possible, which will be enabled by the respective solid oxide material. H⁺ ions or O²⁻ ions can be transported in the decomposition of water depending on the embodiment, for which purpose a solid oxide material which conducts H⁺ ions or O²⁻ ions will selectively be provided.

It is advantageous for improving the ion-conducting properties of the solid oxide material when the solid oxide material is doped with a rare earth metal, especially yttrium.

It is advantageous for achieving a thermally stable photoelectrode with high electron yield under solar radiation when a mixed metal oxide is used as the photoelectrically active material of the first electrode, preferably with perovskite structure, especially strontium titanate (SrTiO₃) or potassium tantalate (KTaO₃). The perovskite structure can be characterized by the summation formula ABO₃. A bivalent cation such as Sr²⁺ is situated in the perfect lattice at location A. The location B is associated with a cation with a quadrivalent positive charge such as Ti⁴⁺, so that in total the neutrality condition is fulfilled.

For forming the first electrode as a p-type semiconductor, it is advantageous when the perovskite mixed metal oxide of the first electrode is doped with an acceptor substance, especially iron. A preferably trivalent cation, especially Fe³⁺, is used as an acceptor substance by doping at location B of the perovskite lattice, so that a positive relative charge is obtained. The relative charge is twice positive for each two trivalent cations (e.g. Fe³⁺), relating to the ideal charging at location B of the perovskite lattice. This enables O²⁻ conduction by the photoactive material of the first electrode. Furthermore, an insertion of O₂ molecules as a component of H₂O can further be achieved. The doping of the electrode material leads to the further advantage that the band gap of the photoelectrically active electrode can be reduced, thereby respectively increasing the proportion of the sunlight spectrum that can be utilized. In the case of Fe-doped strontium titanate (SrTi₁₋ₓFeₓO₃), the band gap of approximately 3.2 eV (without Fe-doping, x=0) can be reduced by Fe-doping with x=0.5 to approx. 2.4 eV. The Fe-content in the crystal is preferably not more than 50% (x=0.5) because otherwise mixed phases could be obtained which would impair the stability of the crystal structure of SrTi₁₋ₓFeₓO₃. Fe-dopings of between x=0.3 and x=0.5 have proven to be appropriate in the performed examinations for the material synthesis of the perovskite mixed metal oxide.

The first electrode can alternatively be made of a transition metal oxide (MeOₓ), preferably Fe₂O₃, CoO, Cu₂O, NiO, SnO₂, TiO₂, WO₃ or ZnO.

It is advantageous for the efficient decomposition of the starting material when the second electrode is made of a catalytically active material, especially RuO₂, LaSrMnO₃, Pt, a ceramic-metal mixture, preferably Ni—YSZ or Ni.

The photoelectrically active first electrode is preferably arranged as a cathode and the second electrode as an anode. Depending on the configuration of the photoelectrochemical cell, an exchanged arrangement of cathode and anode can be provided alternatively.

Conventional electrolytic apparatuses require an external power supply by necessity in order to generate a potential difference between the electrodes. In contrast to this, the charge carriers in the apparatus in accordance with the invention are excited by radiation of the photoactive first electrode. In order to reduce the electron-hole recombination in the first electrode it may be advantageous if the electron conductor comprises a voltage or current source for supporting the transport of the electrons excited by solar radiation.

Electron-hole pairs are generated in the excitation of the photoactive first electrode. The charge carriers can recombine with the ions generated in the conversion of the starting material into a by-product. It is therefore appropriately provided that one of the electrodes is connected to a discharge line for a by-product, especially oxygen, which is produced by the decomposition of the starting material.

It is advantageous for improving ion transport when a catalyst or electron conducting layer especially made of Ag, Au, Pt, RuO₂, Ni, Ni—YSZ, LaSrMnO₃ or LaSrCoO₃ is arranged between one of the electrodes and the electrolyte. YSZ stands as an abbreviation for “yttria-stabilized zirconia”, which is understood as being a ceramic material on the basis of zirconium oxide. The material for the catalyst or electron conducting layer can be chosen in such a way depending on the type of the transported ions, i.e. especially O²⁻ and H⁺ ions, that the desired catalytic effect will be achieved. Moreover, electron transport can be improved.

In order to increase the electron yield in the excitation of the photoactive first electrode, it is advantageous when the first electrode is associated with a device for concentrating the incident solar radiation, which is set up to increase the intensity of a radiation focused on the first electrode by at least 30 times, preferably at least 50 times, in relation to the incident solar radiation. The concentrated solar radiation allows increasing the heat input into the photoelectrochemical cell in order to keep the operating temperature at a level which is substantially increased over room temperature, especially more than 300° C. As a result, the thermal energy of solar radiation, which was neglected in conventional cells of this kind, can be utilized in a purposeful way. The device concentrating the incident solar radiation is especially configured to automatically maintain the increased operating temperature of the photoelectrochemical cell. Moreover, the charge density in the photoactive material of the first electrode can be increased substantially by the focused solar radiation. Preferably, an area-focusing device is provided for concentrating the solar radiation, which includes solar tower power plants which comprise a heliostat and a receiver. Alternatively, a line-focusing device can be arranged, appropriately a parabolic trough collector installation or a Fresnel collector installation.

It is provided in a preferred embodiment of the invention that the electrodes and the electrolyte are accommodated in a flat housing for achieving a panel, which comprises a translucent entrance window, especially a glass pane, which covers the first electrode. The photoelectrically active first electrode is preferably arranged as a large flat panel which can be oriented in the direction of the incident solar radiation. Similar to a photovoltaic system, the panel represents a mechanically stable, compact arrangement which can be set up simply and rapidly. It is provided in an alternative preferred embodiment of the invention that at least the photoactive first electrode facing the solar radiation is curved. Preferably, the photoelectrochemical cell has a substantially cylindrical shape, with the entrance window, the first electrode, the electrolyte and the second electrode being formed by respective hollow-cylindrical layers.

It is advantageous for maintaining an increased operating temperature when the housing is enclosed by an insulating body which comprises a recess corresponding to the entrance window. As a result, the thermal energy of solar radiation can be converted in the cell with high efficiency into internal energy in order to increase the operating temperature of the cell.

The method in accordance with the invention achieves the same advantages as the apparatus in accordance with the invention, so that reference can be made to the statements above for avoiding repetitions.

The excitation of the first electrode, the ion transport between the electrodes and the decomposition of the starting material preferably occurs at an operating temperature of more than 300° C., preferably more than 500° C. These operating temperatures allow considerably reducing the band gap of the semiconducting material of the photoactive first electrode on the one hand, so that the radiation components of the solar radiation which can be utilized for exciting electron-hole pairs can be expanded in the direction towards long-wave radiation. On the other hand, the chemical potential for the decomposition of the starting material will be reduced, so that efficient conversion of the starting material into the product gas will be enabled.

When the first electrode is irradiated with concentrated solar radiation whose intensity is increased over the intensity of the incident solar radiation by at least 30 times, preferably by at least 50 times, electrons will increasingly be lifted into the line band in the first electrode which are conducted via the electron conductor to the second electrode in order to decompose the starting material into the product gas and the respective ions. The focusing of the solar radiation leads to the additional advantage that the operating temperature can be held in the desired range.

It is provided in a preferred embodiment that the operating temperature is reached in a heating process by means of an external heat source, especially a solar installation. Accordingly, the photoelectrochemical cell will be pre-heated at first to the operating temperature. The external heat source will preferably subsequently be decoupled from the cell. The heat input required for maintaining the operating temperature occurs in operation especially by concentrated solar radiation.

A first preferred embodiment of the invention provides that for the decomposition of water superheated steam with a temperature of at least 300° C., preferably more than 500° C., is supplied. The chemical potential for the decomposition of the steam is substantially lower than at room temperatures when water is present in the liquid aggregate state.

A further preferred embodiment provides that carbon dioxide with a temperature of at least 600° C., preferably more than 700° C., is supplied for carbon dioxide decomposition as the starting material. Accordingly, the carbon dioxide is reduced to carbon monoxide at the second electrode, i.e. the cathode.

In accordance with a further preferred embodiment, the starting material is a gas mixture, especially air, from which a gas component, especially oxygen, is separated as the product gas. The gas component will be converted here by means of the excited charge carriers into the associated ions at the electrode connected to the gas mixture supply, which ions will be conducted through the electrolyte to the respectively opposite electrode in order to react there into the molecular product gas. This principle can advantageously be utilized for providing a photon-driven oxygen pump.

It is advantageous for the optimal utilization of solar energy when the thermal energy of the product gas obtained on the second electrode or a gaseous by-product produced on the first electrode is used in a thermal-energy reclamation circuit for heating the starting material. Accordingly, the thermal energy of the product gas or any by-products will not be lost but will be reclaimed in order to heat the starting material concerning the desired operating temperature. The reclamation of the thermal energy occurs preferably by means of heat exchangers which are known in the state of the art in numerous configurations.

In order to keep the operating temperature as constant as possible even in changing conditions, it is advantageous when the operating temperature will be measured and will be controlled to a fixed value. Accordingly, a measuring element will be arranged on the second electrode for example, which measuring element measures the current operating temperature and transmits the temperature as an input quantity to a control loop which controls the operating temperature to the fixed value. For this purpose, the control loop can be coupled to a follow-up control for the photoelectrochemical cell which can influence the angle of inclination of the first electrode in relation to the incident solar radiation. Furthermore, the control loop can be coupled to the external heat source in order to provide additional heat input into the photoelectrochemical cell if necessary.

The invention will be explained below in closer detail by reference to embodiments shown in the drawings, to which they are not limited however. The drawings show the following in detail:

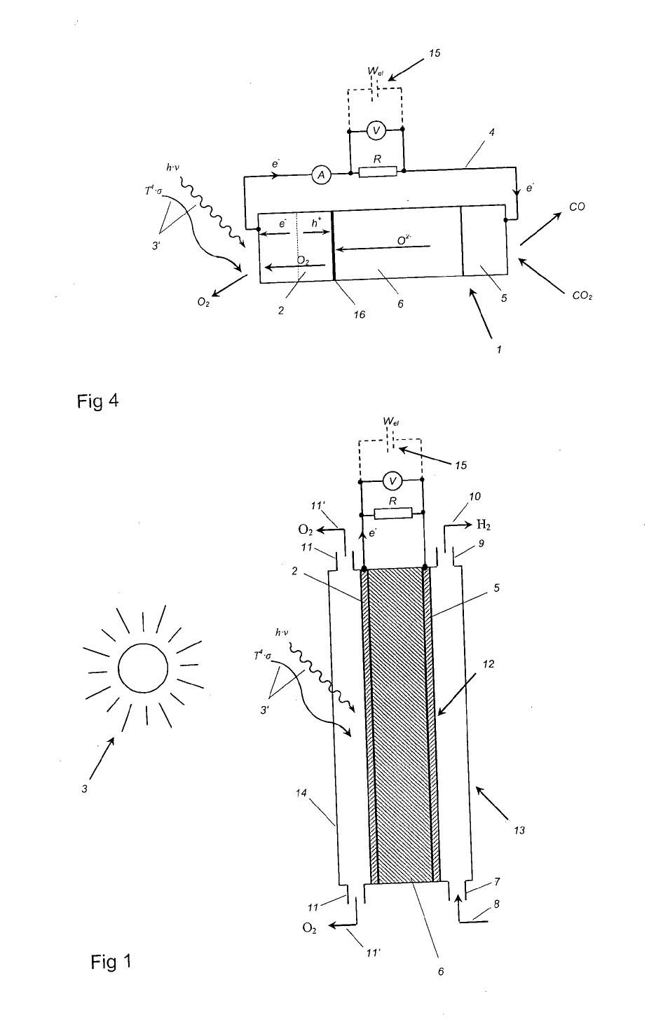

FIG. 1 shows a schematic view of a photoelectrochemical cell which is arranged according to a first embodiment of the invention in the manner of a panel, with two plate-shaped electrodes being provided between which an ion-conducting electrolyte made of a heat-resistant solid material is arranged;

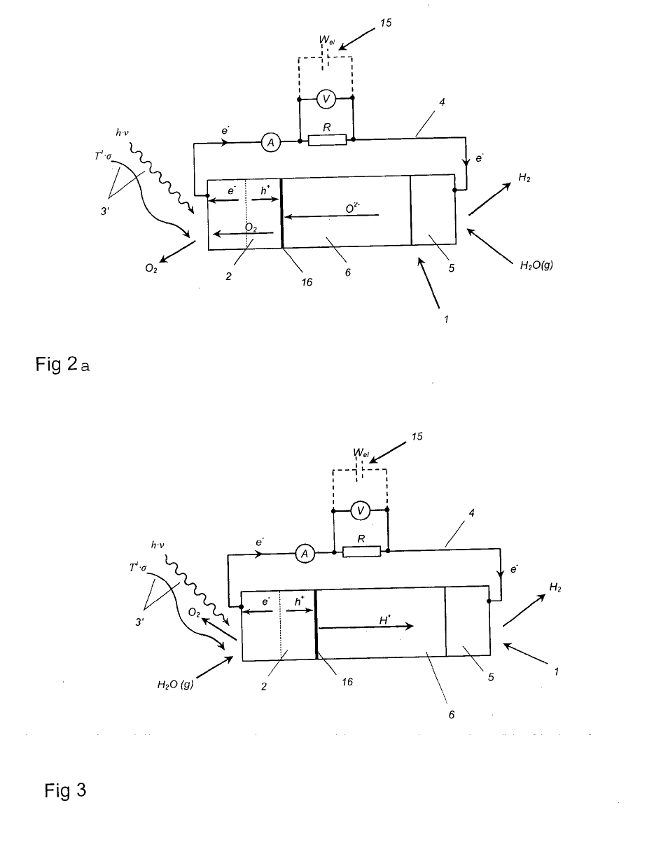

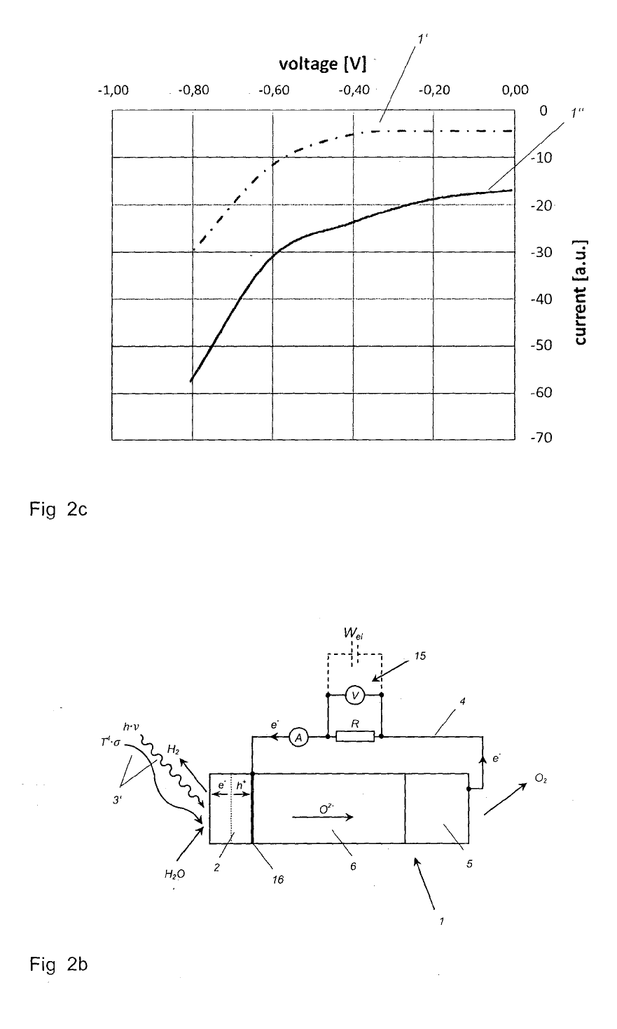

FIG. 2a schematically shows the operating principle of a photoelectrochemical cell for producing hydrogen, which comprises in accordance with a first embodiment a solid oxide electrolyte that conducts O²⁻ ions;

FIG. 2b shows the operating principle of the photoelectrochemical cell according to FIG. 2a, with the photoelectrically active electrode being arranged as the cathode;

FIG. 2c shows a diagram with the current-voltage characteristic of the photoelectrochemical cell as shown in FIG. 2b;

FIG. 3 schematically shows the operating principle of a photoelectrochemical cell for producing hydrogen, with a solid oxide electrolyte that conducts H⁺ ions being provided according to a second embodiment;

FIG. 4 schematically shows the operating principle of a photoelectrochemical cell for reducing carbon dioxide into carbon monoxide;

FIG. 5 shows a block diagram of an installation for the production of hydrogen with a photoelectrochemical cell according to FIG. 2;

FIG. 6a shows a cross-sectional view of a photoelectrochemical cell which is arranged in a cylindrical way according to a further embodiment of the invention;

FIG. 6 b shows a longitudinal sectional view of the photoelectrochemical cell shown in FIG. 6a;

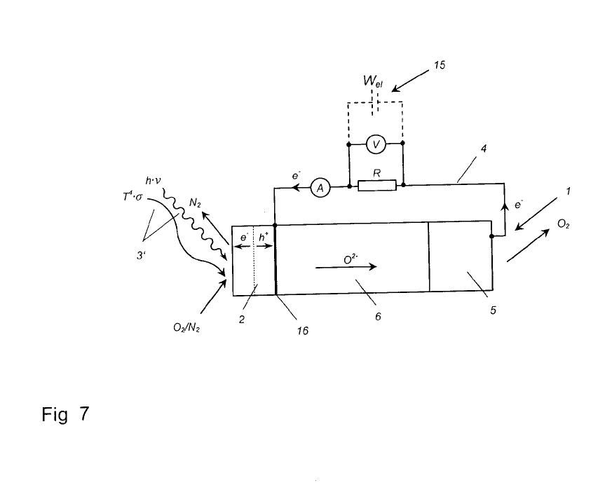

FIG. 7 schematically shows the operating principle of a photoelectrochemical cell arranged according to a further embodiment of the invention which is set up for separating a gas component from a gas mixture.

FIG. 1 schematically shows a photoelectrochemical cell 1 for solar-driven decomposition of a starting material into a product gas bound therein. The obtained product gas is especially a gaseous energy carrier such as (molecular) hydrogen or carbon monoxide. The cell 1 comprises a photoelectrically active first electrode 2, which is subjected in operation to the solar radiation 3′ of the sun 3 (which is schematically shown in FIG. 1). The solar radiation 3′ excites electron-hole pairs in the first electrode 2, which consists of a semiconducting material. The charge carrier density is therefore increased in the first electrode 2 under solar radiation. The excitation of the first electrode 2 is based on the internal photoelectric effect, which means the increase of the conductivity of the electrode material by excitation of electrons from the valence band into the conduction band. For this purpose the energy of the excitation radiation must be larger than the band gap of the semiconducting material of the first electrode 2. The excited electrons will be conducted via an electron conductor 4 to a second electrode 5. An ion conductor 6 is provided for closing the circuit, which ion conductor is set up for the transport of ions between the first electrode 2 and the second electrode 5. In the embodiment as shown in FIG. 1, the second electrode 5 is connected to a feed line 7 by which the starting material is supplied in the direction of arrow 8. The starting material will be decomposed by means of the charge carriers which are present in the first electrode 2 in form of electron-hole pairs, with the produced product gas leaving the photoelectrochemical cell 1 via a discharge line 9 in the direction of arrow 10. Ions are produced in the decomposition of the starting material, which ions are transported between the electrodes 2, 5 via the ion conductor 6. Discharges 11 for a by-product are schematically shown in the region of the first electrode 2, which by-product leaves the photoelectrochemical cell 1 in the direction of the arrow 11′. The arrangement of the feed line 7 and the discharge line 9 depends on the occurring reactions and can differ from the embodiment as shown in FIG. 1, as is shown in FIG. 3. The reactions occurring in the photoelectrochemical cell 1 will be explained below in closer detail by reference to preferred embodiments. The decomposition of water into molecular hydrogen will be described by reference to FIGS. 2 and 3 and the reduction of carbon dioxide into carbon monoxide by reference to FIG. 4.

Known cells of this kind comprise a solution of electrolytes which flows around the electrodes. The solution of electrolytes comes with the disadvantage however that photocorrosion can occur on the irradiated electrode, with the electrode material being dissolved. This can lead to irreparable damage to the cell. Furthermore, only a narrow bandwidth of the solar radiation will disadvantageously be used in the known cells, which are such short-wave radiation components whose photon energy (illustrated in FIG. 1 with “hv”) is larger than the band gap of the semiconducting material of the photoelectrode. The properties of solar radiation 3′ as thermal radiation, which produce a thermal input into the cell 1 according to the Stefan Boltzmann radiation law (illustrated in FIG. 1 with “T⁴σ”), were neglected as an undesirable side effect however.

In contrast to this, it is provided in the photoelectrochemical cell 1 as shown in the drawings that an electrolyte which is made of a heat-resistant solid material and is arranged between the electrodes 2, 5 is provided as an ion conductor 6. A solid oxide material is especially provided as a solid electrolyte, which material is thermally stable over a wide temperature range. On the one hand, photocorrosion of the electrode 2 which frequently occurs in liquid electrolyte solutions can be prevented. On the other hand, the efficiency of the photoelectrochemical cell 1 can be increased because substantially the entire spectrum of solar radiation 3′ will contribute directly or indirectly to the decomposition of the starting material. As in conventional photoelectrochemical cells 1, photo electrons will be excited with the short-wave radiation components in the photoactive material of the first electrode 2. The radiation components with lower photo energy than the band gap of the semiconducting material of the first electrode 2 produce a heat input into the photo electrochemical cell 1. This applies accordingly to the excess energy of the short-wave radiation components, i.e. the energy difference between the higher-energy edge of the band gap and the photon energy. The heat input by the solar radiation 3′ will be converted into internal energy of the photoelectrochemical cell 1 in order to increase the operating temperature of the photoelectrochemical cell 1 in relation to room temperature, which was prevented or undesirable in the known cells. The photoelectrochemical cell 1 can withstand the increased operating temperature by using heat-resistant materials, especially the solid electrolytes for the ion conductor 6. The increase in the operating temperature leads to the positive effect on the one hand that the decomposition voltage required for the decomposition of the starting material into the product gas will decrease. On the other hand, the used semiconducting materials for the photoactive first electrode 2 have a temperature-dependent band gap which will decrease during increase of the temperature. As a result, the electron yield in the photoactive first electrode 2 can be increased, so that a larger current will be conducted to the second electrode 5 which increases the conversion of the starting material into the product gas. As a result of the utilization of the thermal radiation properties, the cell 1 in accordance with the invention is therefore arranged as a photoelectrical-thermochemical cell, for which the abbreviation PETC (“photoelectrical-thermochemical cell”) is proposed.

As is further shown in FIG. 1, the photoelectrochemical cell 1 is arranged as a flat panel 12 which is embedded in a housing 13. The electrodes 2, 5 jointly form a thin-layer configuration with the interposed solid electrolyte, with the electrodes 2, 5 and the solid electrolyte being arranged as large flat panels. A planar arrangement of the photoelectrochemical cells 1 is therefore provided. The housing 13 comprises an entrance window 14 on the side facing the solar radiation 3′, which window is transparent for the impinging solar radiation. The entrance window 14 can be made of quartz glass for this purpose. A compact photoelectrochemical cell 1 is therefore realized, which can be used in the manner of a solar panel.

As is further schematically shown in FIG. 1, the electron conductor 4 can optionally comprise a voltage or current source 15 (designated in FIG. 1 with Wₑₗ), which supports the transport of the electrons excited in the first electrode 2 by the solar radiation 3′ to the second electrode 5. In contrast to known different electrolytic apparatuses, such an external voltage or current source 15 is not necessarily provided because the predominant proportion of the current will be generated by solar radiation in the photoelectrochemical cell 1 itself. The electron conductor 4 comprises a resistor schematically designated in the drawing with reference letter “R”. The potential difference between the electrodes 2, 5 is designated with reference letter “V”.

FIG. 2a, FIG. 2b and FIG. 3 respectively schematically show the application of the photoelectrochemical cell 1 as shown in FIG. 1 for the decomposition of water into molecular hydrogen and oxygen.

Hydrogen was used up until now mostly in the chemical and the metallurgical industry. Hydrogen is used for producing intermediate compounds such as ammonia and methanol or as a chemical reducing agent. A further application lies in the field of the processing of mineral oil and the production of synthetic fuels and lubricants. Hydrogen is currently mostly produced from fossil energy carriers. It can be assumed that the demand for hydrogen will increase. On the one hand, an increased demand can be expected from the chemical industry, e.g. for the production of fertilizers. On the other hand, hydrogen is increasingly gaining in importance as a fuel for generating electricity and heat by means of fuel cells. Hydrogen can therefore contribute to the reduction in the use of fossil fuels. The production of hydrogen as a combustible and fuel only makes sense from an energy and ecological standpoint if regenerative energies are mainly used for this purpose.

As a result, there is a high demand to use regenerative energies efficiently for the production of hydrogen, which can be achieved with the photoelectrochemical cell 1 as shown in FIGS. 2 and 3.

FIG. 2a and FIG. 2b respectively show a first embodiment of the photoelectrochemical decomposition of water, which is based on a solid oxide material conducting O²⁻ ions as the electrolyte.

A heat-resistant metal oxide, appropriately TiO₂ or Cu₂O, with a porous structure and semiconducting properties will be used as the photoactive material for the first electrode 2 according to FIG. 2a. The first electrode 2 will be subjected on one side to solar radiation 3′. The ion conductor 6 is arranged on the side of the first electrode 2 which faces away from the sun 3, which ion conductor is formed by a high-temperature-resistant solid electrolyte, especially a solid oxide electrolyte (e.g. yttrium-doped zirconium dioxide, in short: YSZ, “yttria-stabilized zirconia”). Electron-hole pairs are generated in the semiconducting material of the first electrode 2 during the radiation of the first electrode 2 (equation 1).

2hv→2e⁻+2h⁺ Equation 1

The electrons e⁻ will move in the direction of the irradiated side of the first electrode 2. The holes h⁺ will travel to the boundary surface with the ion conductor 6 against the electron flow. The electrons e⁻ will be conducted via an outer circuit, i.e. via the electron conductor 4, to the opposite electrode 5, which in the embodiment according to FIG. 2a forms the cathode. The electrodes 2, 5 enclose the solid oxide electrolytes as a thin membrane. As a result of the electron flow, the side of the semiconducting material of the first electrode 2 will become the anode in the embodiment according to FIG. 2a. In order to keep the electron-hole recombination in the first electrode 2 at a low level, the solar-produced electron flow via the electron conductor 4 will be supported by the external voltage source 15 which amplifies the photoelectrically generated electrical field. The generated electrons e⁻ will be “sucked off” by means of the voltage source 15, thereby substantially reducing the electron-hole recombination.

Superheated steam H₂O_{(g)}, which forms the starting material for the production of hydrogen, is supplied with a temperature of more than 300° C., especially more than 500° C., to the second electrode 5 which forms the cathode. The electrons e⁻ which reach the second electrode 5 via the electronic conductor 4 will ensure that steam H₂O_{(g)} will be reduced into molecular hydrogen H₂ and oxygen ions O²⁻ (equation 2).

H₂O_{(g)}+2e⁻→H_{2(g)}+O²⁻ Equation 2

The O²⁻ ions will reach the boundary layer to the anode of the semiconducting first electrode 2 through the solid electrolyte of the membrane-like ion conductor 6. The O²⁻ ions will recombine there into molecular oxygen O₂ with the holes h⁺ which travel there from the other side (equation 3).

$${O}^{2 -} + 2 {h}^{+} {\to }^{\frac{1}{2}} {O}_{2 ( g )} \qquad Equation 3$$

As a result of pore diffusion, the molecular oxygen O₂ passes through the semiconducting material of the first electrode 2, will exit from the irradiated side and will be discharged as a by-product. The total reaction (equation 4) of the photoelectrical-thermochemical decomposition of water is the sum total of the individual reaction steps of the equations 1 to 3.

$$2 hv + {H}_{2} {O}_{( g )} \to {H}_{2 ( g )} {+}^{\frac{1}{2}} {O}_{2 ( g )} \qquad Equation 4$$

The method for the decomposition of water runs at operating temperatures of more than 300° C., preferably between 500° C. and 900° C., with the increased operating temperature being produced at least partly by the heat input of solar radiation 3′. The thermodynamically required voltage potential (decomposition voltage) of 1.23 V at room temperature (298.15 K) and an ambient pressure of 1 bar decreases to approx. 1-0.9 V at temperatures of 500° C. to 900° C., or 773.15 to 1173.15 K respectively. In order to increase the heat input into the photoelectrochemical cell 1, concentrated solar radiation 3″ is preferably used, as will be explained below in closer detail in connection with FIG. 5.

FIG. 2b shows a variant of the photoelectrochemical cell 1 according to FIG. 2a, in which a mixed metal oxide with perovskite structure, preferably strontium titanate, is provided as the photoelectrically active material of the first anode 2, which structure is doped with an acceptor substance, preferably iron. The use of Fe-doped strontium titanate with the summary formula SrTi₁₋ₓFeₓO₃ allows a significant decrease of the band gap of the first electrode 2, so that a comparatively large proportion of the sunlight can be utilized for decomposing the starting material. The Fe-doping x of the preferred electrode material SrTi₁₋ₓFeₓO₃ is preferably less than 0.5 in order to prevent the production of mixed phases.

As is further shown in FIG. 2b, the first electrode 2 is arranged here as a cathode and the second electrode 5 as the anode, so that the excited electrons will flow from the second electrode 5 to the first electrode 2. The starting material will be supplied to the first electrode 2 in this embodiment. The molecular oxygen O₂ will be obtained on the second electrode 5, whereas the molecular hydrogen H₂ will be produced on the first electrode 2.

The diagram of FIG. 2c shows the current I between the electrodes 2, 5 depending on the external voltage U of the current source 15 on the basis of the example of the photoelectrochemical cell 1 as shown in FIG. 2b. FIG. 2c shows a current-voltage characteristic 1′ (upper characteristic in FIG. 2c) for the case without solar radiation and a current-voltage characteristic 1″ (bottom characteristic in FIG. 2c) for the operation of the photoelectrochemical cell 1 under solar radiation. A non-vanishing current I between the electrodes 2, 5 will accordingly be achieved without photoelectrical activation only at higher negative voltage values. In contrast to this, the radiation of the first electrode 2 (cf. current-voltage characteristic 1″) ensures that a current I will flow between the electrode 2, 5 even without external voltage U. The current flow will be increased accordingly by applying a (negative) external voltage U.

FIG. 3 shows an alternative embodiment of the photoelectrochemical decomposition of water into molecular hydrogen and molecular oxygen, which provides a solid oxide material as electrolyte which conducts H⁺ ions (protons). A mixed lanthanum oxide is especially suitable for the transport of the H⁺ ions.

The processes that are performed in the photoelectrochemical cell 1 according to FIG. 3 are characterized by the equations 5 to 9 as provided below.

The solar generation of electronic-hole pairs occurs on the first electrode 2, according to FIG. 2a (equation 5):

2hv→2e⁻+2h⁺ Equation 5

Steam H₂O_{(g)} is supplied in this embodiment to the first electrode 2 which is appropriately made of Cu₂O. The photoelectrically generated holes h⁺ produce in the first electrode 2 an anodic oxidation of the steam H₂O_{(g)}, with molecular oxygen O₂ and hydrogen ions H⁺ being produced which travel in the direction of the boundary layer to the ion conductor 6 (equation 6):

$${H}_{2} {O}_{( g )} + 2 {h}^{+} {\to }^{\frac{1}{2}} {O}_{2 ( g )} + 2 {H}^{+} \qquad Equation 6$$

The oxygen O₂ will be discharged as a by-product of hydrogen generation. The hydrogen ions H⁺ reach the second electrode 5 via the ion conductor 6, i.e. to the cathode, which is appropriately made of platinum. The H⁺ ions will combine with the supplied electrons e− into molecular hydrogen H₂ which is discharged as the product gas (equation 7):

2H⁺+2e⁻→H_{2(g)} Equation 7

The photoelectrochemical total reaction can therefore be read as follows (equation 8):

$$2 hv + {H}_{2} {O}_{( g )} \to {H}_{2 ( g )} {+}^{\frac{1}{2}} {O}_{2 ( g )} \qquad Equation 8$$

Depending on the configuration of the photoelectrochemical cell 1 according to FIG. 3, the flow of electrons between the electrodes 2, 5 can also occur against the illustrated direction (such an arrangement of the electrodes 2, 5 is shown in FIG. 2b for the cell 1 shown there). In this case, the water is supplied in the cell according to FIG. 3 to the second electrode 5 which is arranged as an anode and the molecular oxygen O₂ will be discharged, whereas the molecular hydrogen H₂ is produced on the first electrode 2 arranged as the cathode.

As is schematically further shown in FIG. 2 and FIG. 3, one respective catalyst or electron conducting layer 16 is arranged between the solid electrolyte and the first electrode 2. The material for this catalyst or electron conducting layer 16 depends on the ions which are transported via the electrolyte. For promoting the hydrogen development in the case of H⁺ ion conduction, a thin layer made of platinum can appropriately be provided. The oxygen development in the case of O²⁻ ion conduction can be catalyzed with a catalyst or electron conducting layer 16 made of ruthenium oxide (RuO₂).

Especially when using a perovskite mixed metal oxide (e.g. strontium titanate) for the photoactive first electrode 2, the arrangement of the electron conducting layer 16 offers the especially advantageous effect that the electrical surface or lateral resistance of the cathode material can be reduced in this way, which in the case of strontium titanate is approx. 10³ Ωcm⁻². The electron conducting layer 16 should impair the ion transport (e.g. of O²⁻ ions) between the electrodes 2, 5 as little as possible. It is advantageous in this respect when the electron conducting layer 16 has a net-like, strip-like or meandering structure which promotes the ion flow. Platinum (Pt), silver (Ag), gold (Au) and also electrically conductive mixed metal oxides such as lanthanum-strontium cobalate (LaSrCoO₃, LSC) or lanthanum-strontium manganate (LaSrMnO₃, LSM) have proven to be advantageous as well-conducting materials for the electron conducting layer 16.

FIG. 4 schematically shows a photoelectrochemical cell 1, which is arranged for the reduction of carbon dioxide CO₂ into carbon monoxide CO according to a further embodiment of the invention. Reference is hereby made to the photoelectrochemical cell 1 with solid oxide material that conducts O²⁻ ions as explained in connection with FIG. 3 concerning the materials for the ion conductor 6, the catalyst and electron conducting layer 16 and the electrodes 2, 5.

Equation 9 shows the generation of electron-hole pairs occurring on the first electrode 2:

2hv→2e⁻+2h⁺ Equation 9

The carbon dioxide CO₂ will be supplied to the second electrode 5 in order to react with the supplied electrons e⁻ into carbon monoxide CO and oxygen ions O²⁻ (equation 10):

CO_{2(g)}+2e⁻→CO_{(g)}+O²⁻ Equation 10

O²⁻ ions will travel through the ion conductor 6 in order to recombine with the photogenerated holes h′ under formation of molecular oxygen (equation 11):

$${O}^{2 -} + 2 {h}^{+} {\to }^{\frac{1}{2}} {O}_{2 ( g )} \qquad Equation 11$$

The photoelectrochemical total reaction is therefore as follows:

$$2 hv + {CO}_{2 ( g )} \to {CO}_{( g )} {+}^{\frac{1}{2}} {O}_{2 ( g )} \qquad Equation 12$$

The conversion of the carbon dioxide occurs at a temperature of at least 600° C., preferably more than 700° C., in order to utilize the advantages of the reduced band gap of the semiconducting material of the first electrode 2 and the lower decomposition voltage as explained on the basis of the decomposition of water. As already mentioned, the arrangement of the electrodes 2, 5 can also be exchanged, so that the first electrode 2 is arranged as the cathode and the second electrode 5 as the anode. In this case, the carbon dioxide CO₂ will be supplied to the first electrode 2 which is arranged as the cathode and the obtained carbon monoxide CO will be discharged. The molecular oxygen will be discharged on the second electrode 5 which is arranged as the anode.

FIG. 5 shows an arrangement 17 for the production of hydrogen with a photoelectrochemical cell 1 according to FIG. 2a in a schematic block diagram. It is understood that the arrangement 17 can alternatively also be provided with the electrochemical cell 1 as shown in FIG. 2b, FIG. 3 or FIG. 4 in order to enable an alternative embodiment of water decomposition (according to FIG. 2b, FIG. 3) or the reduction of carbon dioxide (according to FIG. 4).

As is shown in FIG. 5, the photoelectrochemical cell 1 is enclosed by an insulating body 18 which protects the photoelectrochemical cell 1 from heat radiation in order to maintain the desired increased operating temperature (designated in FIG. 5 with T_{B}). The insulating body 18 comprises a recess 19 which is open in the direction of the incident solar radiation 3′ and which accommodates the photoelectrochemical cell 1. The solar radiation 3′ will be injected via the entrance window 14 into the photoelectrochemical cell 1.

In order to increase the heat input into the photoelectrochemical cell 1, a device 19 for concentrating the incident solar radiation 3′ is arranged between the radiation source 3 and the photoelectrochemical cell 1. The intensity of the concentrated solar radiation 3″ which impinges on the first electrode 2 will preferably be increased by means of the device 19 by a factor of at least 30, especially by a factor of at least 50, in relation to the intensity of the incident solar radiation 3′. The focusing of the solar radiation can be achieved with focusing apparatuses which are generally known in the state of the art. In the case of the panel shown in FIG. 1 and FIG. 5 with a substantially flat electrode 2, an area-focusing device 19 is appropriately provided, e.g. a heliostat known from solar tower power plants for example. The heat input by the concentrated solar radiation 3″ allows keeping the operating temperature T_{B} of cell 1 at a level which is substantially increased over room temperature. As was already described above, the increased operating temperature T_{B} is advantageous with respect to the efficiency of the processes occurring in the photoelectrochemical cell 1. FIG. 5 further schematically shows an optical unit 21 which is arranged to project the solar radiation 3″ which is concentrated by means of the device 19 in a suitable manner onto the photoactive first electrode 2. FIG. 5 further schematically shows the external current and voltage source 15 which is optionally connected to the electron conductor 4 in order to support the current flow between the electrodes 2, 5.

The arrangement 17 is set up to automatically maintain the increased operating temperature T_{B} via the injected solar radiation 3′, 3″. In order to reach the operating temperature T_{B} in one heating process, an external heat source 22 is provided which is set up for transferring a heat flow Q₁ to the photoelectrochemical cell 1. The external heat source 22 can further be used for buffering fluctuations in the solar radiation 3′ which occur in operation. For this purpose, the heat source 22 is set up to transfer a variable heat flow Q₁ as required to the photoelectrochemical cell 1 or to receive a variable heat flow Q₂ from the photoelectrochemical cell 1. The heat source 22 will be supplied by a solar installation for example. It is understood that a heat source 22 can be considered on the basis of electrical or chemical energy.

The arrangement 17 comprises a feed 23 for the starting material, i.e. water H₂0, which is conducted via a superheater 24 that produces superheated steam H₂0_{(g)} with a temperature of preferably at least 300° C. The superheated steam H₂0_{(g)} will be supplied to the second electrode 5 of the photoelectrochemical cell 1, in which the processes described in connection with FIG. 2 take place for decomposing the steam H₂0_{(g)} into molecular oxygen O₂ and molecular hydrogen H₂. A mixture of molecular hydrogen H₂ and steam H₂0_{(g)} is produced in the second electrode 5, which mixture contains a specific thermal quantity Q. The mixture of molecular hydrogen H₂ and steam H₂0_{(g)} will be supplied to a separator 25 which will separate the product gas H₂ and the remaining steam H₂0_{(g)}. The separator 25 is further set up as a thermal energy reclamation device in order to transfer a heat flow Q₃ of the H₂/H₂0_{(g)} gas mixture to the superheater 24. Accordingly, the thermal energy of the product gas (or the remaining starting material) is used for heating the starting material in a thermal energy reclamation circuit. For this purpose, a heat exchanger can be used, which is known in numerous configurations in the state of the art. The separator 25 is connected to a storage unit 26 which receives the cooled product gas H₂. The cooled water H₂O will be supplied to a separate storage unit 27 which can be connected via a recirculation 28 to the feed 23 in order to obtain a closed water circuit. Molecular oxygen O₂ is produced on the first electrode 2 (and on the second electrode 5 in the embodiment as shown in FIG. 3) during water decomposition in the photoelectrochemical cell 1, which oxygen is guided via a discharge 11 to a further thermal energy reclamation device 29 which transfers a heat flow Q₄ to the superheater 24 in order to utilize the thermal energy of the by-product for heating the starting material. The cooled by-product O₂ will be supplied to a storage unit 30.

In order to enable the compensation of fluctuations in the operating temperature T_{B}, a control circuit 31 is provided which controls the operating temperature T_{B} to a fixed value. The control circuit 31 comprises a measuring element 32 for measuring the operating temperature T_{B}, which measuring element can be arranged on the second electrode 5 for example. The measuring element 32 supplies the operating temperature T_{B} to a controller 33 which determines a control deviation from a fixed value for the operating temperature T_{B}. In order to adjust the operating temperature T_{B}, the controller 33 is connected to the external heat source 22 in order to increase or decrease the heat input into the photoelectrochemical cell 1 according to the control deviation. The controller 33 can additionally or alternatively be provided with a follow-up control 34 which can influence the angle of inclination between the solar radiation 3′ (or 3″) and the photoelectrochemical cell 1, especially the first electrode 2.

FIGS. 6a and 6b show an embodiment of the invention which is alternative to the panel-like arrangement of the photoelectrochemical cell 1 according to FIGS. 1, 5 and which provides a rod-like or cylindrical configuration.

In accordance with FIGS. 6a, 6b, the entrance window 14, the first electrode 2, the electrolyte 6 and the second electrode 5 are arranged from the outside to the inside as mutually adjacent hollow-cylindrical layers. Alternatively, a configuration can also be considered with layers that are curved in another manner, e.g. curved in a spherical way. Furthermore, an insulating body 18 is shown which is shaped in the manner of a half-shell and which encloses the half of the photoelectrochemical cell 1 which faces away from the radiation source 3.

FIG. 6b further schematically shows the feed line of the starting material in the direction of arrow 7 and the discharge of the product gas in the direction of arrow 10 on the second electrode 5. The gaseous by-product which is obtained in the decomposition of the starting material will be discharged by a discharge 11 in the direction of arrow 11′.

A line-focusing device 19 for concentrating the incident solar radiation 3′ is provided in the embodiment of the photoelectrochemical cell 1 as shown in FIGS. 6a, 6b, which device can be formed for example by a parabolic trough concentrator or a Fresnel concentrator.

The embodiment of the photoelectrochemical cell 1 as shown in FIGS. 6a, 6b can be operated according to the embodiment explained in connection with FIGS. 1 to 5, so that reference can be made to the explanations above, especially also concerning the used materials, preferred operating conditions and temperature ranges.

FIG. 7 schematically shows the operating principle of a photoelectrochemical cell 1 which is arranged according to a further embodiment of the invention and which is set up for separating a gas component from a gas mixture. In the illustrated embodiment, a gas mixture (which is air in the illustrated example) is supplied to the first electrode 2. As is known, the air flow contains molecular nitrogen N₂ and molecular oxygen O₂. As described above, charge carriers are formed on the first electrode 2 under solar radiation, which charge carriers react with the supplied gas mixture. In this process, O²⁻ ions are formed which are guided through the electrolyte 6 to the second electrode 5, where molecular oxygen O₂ is produced. A photon-supported air pump is provided thereby.

1-22. (canceled)

23. A photoelectrochemical cell for the solar-driven decomposition of a starting material into a product gas bound therein, the photoelectrochemical cell comprising:
a feed line for the starting material;
a discharge line for the obtained product gas;
a first electrode comprising a photoelectrically active material and exposed to solar radiation during operation;
a second electrode,
an electron conductor which connects the first and second electrodes to each other in a closed circuit and which transports electrons excited by the solar radiation in the first electrode;
an ion conductor which transports ions produced in a decomposition of the starting material, wherein the ion conductor comprises an electrolyte arranged between the first and second electrodes and is composed of a heat-resistant solid material.

24. The photoelectrochemical cell of claim 23, wherein the electrolyte comprises one of zirconium dioxide (ZrO₂), lanthanum zirconate (LaZrO₃), and lanthanum cerate (LaCeO₃).

25. The photoelectrochemical cell of claim 24, wherein the solid oxide material is doped with a rare earth metal, especially yttrium.

26. The photoelectrochemical cell of claim 23, wherein the photoelectrically active material comprises one of strontium titanate (SrTiO₃) and potassium tantalate (KTaO₃).

27. The photoelectrochemical cell of claim 26, wherein the one of strontium titanate (SrTiO₃) and potassium tantalate (KTaO₃) is doped with iron.

28. The photoelectrochemical cell of claim 23, wherein the first electrode comprises one of Fe₂O₃, CoO, Cu₂O, NiO, SnO₂, TiO₂, WO₃ and ZnO.

29. The photoelectrochemical cell of claim 23, wherein the second electrode comprises one of RuO₂, LaSrMnO₃, Pt, Ni—YSZ and Ni.

30. The photoelectrochemical cell of claim 23, wherein the electron conductor comprises one of a voltage and a current source which supports the transport of the electrons excited by solar radiation.

31. The photoelectrochemical cell of claim 23, wherein one of the first electrode and the second electrode is connected to a discharge for a gaseous by-product produced by the decomposition of the starting material.

32. The photoelectrochemical cell of claim 23, further comprising one of a catalyst and electron conducting layer, composed of one of Ag, Au, Pt, RuO₂, Ni, Ni—YSZ, LaSrMnO₃ and LaSrCoO₃, and which is arranged between one of the first electrode and the electrolyte and the second electrode and the electrolyte.

33. The photoelectrochemical cell of claim 23, further comprising a device which concentrates the incident solar radiation and which is configured to increase the intensity of solar radiation concentrated on the first electrode relative to the incident solar radiation.

34. The photoelectrochemical cell of claim 23, wherein the first and second electrodes and the electrolyte are accommodated in a housing comprising a transparent entrance window which covers the first electrode, the first and second electrodes, the electrolyte and the housing collectively forming a panel.

35. The photoelectrochemical cell of claim 34, wherein the housing is enclosed by an insulating body which comprises a recess that corresponds to the entrance window.

36. A method for a solar-driven decomposition of a starting material into a product gas bound therein, the method comprising:
exciting charge carriers in the form of electron-hole pairs in a photoelectrically active first electrode via solar radiation, and which are conducted to a second electrode;
supplying one of the first electrode and the second electrode with the starting material which is decomposed by the excited charge carriers;
producing and transporting ions in a closed circuit to the respective other one of the first electrode and the second electrode via a solid oxide material; and
discharging the obtained product gas will be discharged.

37. The method of claim 36, wherein the excitation of the first electrode, the ion transport and the decomposition of the starting material occur at an operating temperature of more than 500° C.

38. The method of claim 36, further comprising irradiating the first electrode with concentrated solar radiation whose intensity is increased by at least 50 times, relative to the intensity of the incident solar radiation.

39. The method of claim 36, wherein an operating temperature is reached in a heating process by way of an external heat source.

40. The method of claim 36, wherein the starting material comprises superheated steam with a temperature of more than 500° C., and which is supplied for the decomposition of water.

41. The method of claim 36, wherein the starting material comprises carbon dioxide with a temperature of more than 700° C., and which is supplied for the decomposition of carbon dioxide.

42. The method of claim 36, wherein the starting material comprises a gas mixture from which a gas component is separated as a product gas.

43. The method of claim 36, wherein the thermal energy of the product gas obtained on the second electrode or a gaseous by-product which is obtained on the first electrode is used in a thermal energy reclamation circuit for heating the starting material.

44. The method of claim 37, further comprising measuring the operating temperature and then controlling the operating temperature to a fixed value.
